(19) United States
(12) Patent Application Publication
(10) Pub. No.: US 2023/0279599 A1
(43) Pub. Date: Sep. 7, 2023

(54) PROCESS AND APPARATUS FOR PRODUCING ELECTROSTATICALLY CHARGED FIBRES AND AN ELECTRET PRODUCT

(71) Applicant: Oerlikon Textile GmbH & Co. KG, Remscheid (DE)

(72) Inventors: Frank Knabe, Kirchbarkau (DE); René Millies, Kiel (DE); Ralph Berkemann, Albstadt (DE)

(21) Appl. No.: 18/116,393

(22) Filed: Mar. 2, 2023

(30) Foreign Application Priority Data
Mar. 4, 2022 (DE) 102022000777.0

(51) Int. Cl. D06B 1/02; D06B 5/06

(52) U.S. Cl. CPC D06B 1/02; D06B 5/06; D10B 2401/16

(57) ABSTRACT

Techniques produce electrostatically charged fibres, and in particular produce an electret fibre construct, where fibres are produced from a plastics and/or natural-origin material, where a polar liquid is atomized using a gaseous pressure medium to produce a treatment aerosol and where the fibres are treated with the treatment aerosol for electrostatic charging, wherein the atomizing is undertaken with a quotient of the volume flow of the polar liquid in litres per second and the positive pressure of the gaseous pressure medium in hectopascals of 0.004 to 0.008.

The present invention relates to a process for producing electrostatically charged fibres, in particular for producing an electret fibre construct. The present invention further relates to an apparatus for producing electrostatically charged fibres, in particular for producing an electret fibre construct. Finally, the present invention relates to an electret product, in particular an electret fibre and/or an electret fibre nonwoven.

By means of so-called hydrocharging, fibres or constructs produced with such fibres can be electrostatically charged. Such electrostatic charging may for example also have an advantageous effect on the filtration properties of a fibre construct. So-called hydrocharging includes producing aerosols and/or vapour from a polar liquid and under certain operating conditions releasing charges which are deposited on a fibre material, for example a nonwoven, or fibres made of polymers. Using additives these charges may be semi-permanently anchored on the respective fibre surface and consequently increase the filtration efficiency of such a filter material.

However, hydrocharging is associated with a moistening of the respective fibres/the respective fibre construct. This moistening can result in corrosion and mould formation in further processing steps. In order to avoid such consequences of moistening an active drying of the fibres/the fibre construct is provided. However, such a drying increases the production costs and the complexity of the production plants employed therefor. In addition, an active drying is associated with increased energy demand which additionally increases the production costs.

Against the backdrop set out above it is an object of the present invention to specify a process for producing electrostatically charged fibres which may be carried out with reduced production and energy costs while simultaneously achieving high operational reliability and high resulting product quality. It was a further object of the invention to specify an apparatus for producing electrostatically charged fibres and an electret product.

Having regard to the process the object has been achieved by the subject matter disclosed herein. An apparatus is disclosed herein and an electret product has been disclosed herein. Further advantageous embodiments are disclosed herein.

A first aspect of the present invention relates to a process for producing electrostatically charged fibres, in particular for producing an electret fibre construct, where fibres are produced from a plastics and/or natural-origin material, where a polar liquid is atomized using a gaseous pressure medium to produce a treatment aerosol and where the fibres are treated with the treatment aerosol for electrostatic charging. According to the invention the atomizing is undertaken with a quotient of the volume flow of the polar liquid in litres per hour and the positive pressure of the gaseous pressure medium in hectopascals of 0.004 to 0.008.

Thus, according to the invention the atomizing is undertaken at a ratio of the volume flow of the polar liquid in litres per hour to the positive pressure of the gaseous pressure medium in hectopascals of 0.004 to 0.008.

Using such a quotient/such a ratio allows a relatively large amount of charges to be produced and applied to the respective fibres. Simultaneously, such a quotient/such a ratio allows the amount of the produced treatment aerosol to be sufficiently limited or minimized. This ensures that an only relatively slight moistening of the fibres or of the fibre construct is effected. An active drying of the electrostatically charged fibres can accordingly be avoided, thus appreciably reducing the production costs and the energy costs required for production. The sufficient electrostatic charge simultaneously ensures a high filtration efficiency of the fibre construct produced from fibres produced in such a way.

The positive pressure of the gaseous pressure medium may preferably be a positive pressure relative to ambient pressure. A positive pressure of the gaseous pressure medium may thus relate to the pressure difference between the pressure of the gaseous pressure medium relative to ambient pressure. A positive pressure relative to ambient pressure makes it possible to undertake particularly advantageous atomization with high operational reliability.

The positive pressure of the gaseous pressure medium may also refer to an absolute pressure. An absolute pressure is to be understood as meaning a pressure relative to a reference pressure of zero, i.e. a pressure which prevails under vacuum/in a space free of air.

The fibres may advantageously be produced from any meltable and/or soluble material or include meltable and/or soluble material. It is particularly preferable to use a polymer melt. The polymer melt may in particular be polypropylene (PP), polycarbonate (PC), polyamide (PA), polyethylene (PE), polylactic acid (PLA), polyvinylidene fluoride (PVDF) or mixtures of these polymers.

In a preferred embodiment of the process according to the invention the atomizing may be undertaken with a quotient of the volume flow of the polar liquid in litres per hour and the positive pressure of the gaseous pressure medium in hectopascals of 0.005 to 0.007, in particular of 0.006 or of about 0.006. This makes it possible to particularly reliably achieve electrostatic charging coupled with low moistening of the fibres.

A further aspect of the present invention relates to a process for producing electrostatically charged fibres, in particular for producing an electret fibre construct, where fibres are produced from a plastics and/or natural-origin material, where a polar liquid is atomized using a gaseous pressure medium to produce a treatment aerosol and where the fibres are treated with the treatment aerosol for electrostatic charging, wherein the atomizing is undertaken with a quotient of the mass flow of the polar liquid and the mass flow of the gaseous pressure medium of 1.4 to 3.

Using such a quotient/such a ratio allows a relatively large amount of charges to be produced and applied to the respective fibres. Simultaneously, such a quotient/such a ratio allows the amount of the produced treatment aerosol to be sufficiently limited or minimized. This ensures that an only relatively slight moistening of the fibres or of the fibre construct is effected. An active drying of the electrostatically charged fibres can consequently be avoided, thus appreciably reducing the production costs and the energy costs required for production. Finally, the sufficient electrostatic charge simultaneously ensures a high filtration efficiency of the fibre construct produced from fibres produced in such a way.

The aforementioned further aspect of the present invention may be realized alternatively or in addition to the likewise above-described first aspect of the present invention. Thus, the atomizing may be undertaken both with a quotient of the volume flow of the polar liquid in litres per second and the positive pressure of the gaseous pressure medium in hectopascals of 0.004 to 0.008 and simultaneously also with a quotient of the mass flow of the polar liquid and the mass flow of the gaseous pressure medium of 1.4 to 3. According to the invention the atomizing may likewise be realized with only one of the recited quotients.

In an advantageous embodiment the atomizing may be undertaken with a quotient of the mass flow of the polar liquid and the mass flow of the gaseous pressure medium of 1.5 to 2.9, in particular of 2 to 2.5. This makes it possible to particularly reliably achieve electrostatic charging coupled with low moistening of the fibres.

A further aspect of the present invention relates to a process for producing electrostatically charged fibres, in particular for producing an electret fibre construct, where fibres are produced from a plastics and/or natural-origin material, where a polar liquid is atomized using a gaseous pressure medium to produce a treatment aerosol and where the fibres are treated with the treatment aerosol for electrostatic charging, wherein the atomizing is undertaken with a quotient of the volume flow of the polar liquid and the volume flow of the gaseous pressure medium of 0.001 to 0.004.

Using an above-described quotient/such a ratio also allows a suitably large amount of charges to be produced and applied to the respective fibres. Simultaneously, such a quotient/such a ratio in turn allows the amount of the produced treatment aerosol to be sufficiently limited or minimized. This advantageously ensures that an only relatively slight moistening of the fibres or of the fibre construct is effected. An active drying of the electrostatically charged fibres can thus be avoided, thus appreciably reducing the production costs and the energy costs required for production. The thus-achieved sufficient electrostatic charge makes it possible to ensure a high filtration efficiency of the fibre construct produced from fibres produced in such a way.

The above-described still further aspect of the present invention may be realized alternatively or in addition to the likewise above-described aspects of the present invention. Thus, the atomizing may be undertaken both with a quotient of the volume flow of the polar liquid and the volume flow of the gaseous pressure medium of 0.001 to 0.004 and simultaneously also with a quotient of the volume flow of the polar liquid in litres per hour and the positive pressure of the gaseous pressure medium in hectopascals of 0.004 to 0.008 and/or with a quotient of the mass flow of the polar liquid and the mass flow of the gaseous pressure medium of 1.4 to 3. According to the invention the atomizing may likewise be realized with only one of the recited quotients.

To the extent that reference is presently made to electrically charged fibres these may in particular be so-called electret fibres. An electret fibre construct may in particular be an electret fibre nonwoven.

An electret may presently be understood as meaning a semipermanently or permanently electrostatically charged construct, for example an electrostatically charged filter nowoven.

The nozzle apparatus may advantageously be configured for producing a treatment aerosol by atomizing a polar liquid using a gaseous pressure medium, wherein the average droplet size of the thus-produced treatment aerosol may be <100 μm.

In a preferred embodiment the atomizing may be undertaken at ambient conditions at an ambient temperature between 0° C. and 30° C., in particular between 15° C. and 25° C. or between 20° C. and 25° C. Furthermore, in a preferred embodiment the atomizing may be undertaken at an ambient pressure of 900 hectopascals to 1100 hectopascals, in particular at about 1000 hectopascals or at 1013.25 or about 1013.25 hectopascals. Such operating conditions may be ensured at relatively low cost, and guarantee reproducible product quality.

In yet further preferred fashion the atomizing of the polar liquid may be undertaken via at least one two-fluid nozzle, in particular with a plurality of two-fluid nozzles. A two-fluid nozzle allows particularly dependable and uniform atomization of a liquid and thus ensures an altogether high level of operational reliability. Such a two-fluid nozzle may particularly advantageously be configured as a flat jet nozzle to allow suitable spatial distribution of the produced aerosol.

In a further preferred embodiment the atomizing may be undertaken in a two-fluid nozzle or per two-fluid nozzle at a volume flow of the polar liquid of 3.2 litres per hour to 5.2 litres per hour, in particular at a volume flow of the polar liquid of 4.2 litres per hour or about 4.2 litres per hour. Such a volume flow may be suitably atomized in a two-fluid nozzle while simultaneously ensuring sufficient electrostatic charging of the fibres to be charged in each case.

The atomizing may yet further preferably be undertaken in a two-fluid nozzle or per two-fluid nozzle at a mass flow of the polar liquid of 3.2 kilograms per hour to 5.2 kilograms per hour, in particular at a mass flow of the polar liquid of 4.2 kilograms per hour or about 4.2 kilograms per hour. Such a mass flow may likewise be suitably atomized in a two-fluid nozzle while simultaneously ensuring sufficient electrostatic charging of the fibres to be charged in each case.

The atomizing of the polar liquid may yet further preferably be undertaken at a positive pressure of the gaseous pressure medium of 500 to 900 hectopascals, in particular at a positive pressure of the gaseous pressure medium of 700 hectopascals or about 700 hectopascals. Such a positive pressure of the gaseous pressure medium ensures dependable atomizing of the polar liquid, in particular at an above-specified volume flow and/or mass flow of the polar liquid per two-fluid nozzle. This can further improve operational reliability.

The atomizing may yet further preferably be undertaken in a two-fluid nozzle or per two-fluid nozzle at a mass flow of the gaseous pressure medium of 2.1 to 2.7 kilograms per hour, in particular at a mass flow of the polar liquid of 2.1 to 2.5 kilograms per hour or 2.3 to 2.7 kilograms per hour. Such a mass flow of the gaseous pressure medium per two-fluid nozzle can be provided at low cost and simultaneously ensures reliable atomizing of the polar liquid, in particular at an above-specified volume flow and/or mass flow of the polar liquid per two-fluid nozzle. This can further improve operational reliability.

Alternatively or in addition the atomizing in a two-fluid nozzle or per two-fluid nozzle may be undertaken with a volume flow of the gaseous pressure medium of 1.5 to 2.5 cubic metres per hour, with a volume flow of the gaseous pressure medium of 1.8 to 2.1 cubic metres per hour. Simultaneously, the atomizing in a two-fluid nozzle or per two-fluid nozzle may be undertaken with a volume flow of the polar liquid of 0.002 to 0.008 cubic metres per hour. Such a volume flow of the gaseous pressure medium and/or of the polar liquid per two-fluid nozzle makes it possible to ensure reliable atomizing of the polar liquid, in particular at an above-specified volume flow and/or mass flow of the polar liquid per two-fluid nozzle. This can further improve operational reliability.

The polar liquid employed may further preferably be water. The gaseous pressure medium may yet further preferably be a compressible gas, preferably air and/or air-comprising gas. Polar liquid in the form of water and/or air as the gaseous pressure medium may be provided at low cost and are suitable for producing a treatment aerosol for the electrostatic charging of fibres.

The fibres may yet further preferably be treated/sprayed with the treatment aerosol before consolidation to afford a fibre nonwoven and/or before laydown on a collecting apparatus, in particular on a laydown belt. The fibres may likewise be treated/sprayed with the treatment aerosol before capture by a vacuum source. Such spraying may be carried out directly by the respective two-fluid nozzles.

Laydown on a collecting apparatus, on a laydown belt or by capture using a vacuum source already effects sufficient drying of the fibres treated with the treatment aerosol and there is therefore no need for an additional or specific active drying.

The fibres may yet further preferably be produced by melt blowing. In this case the fibres may be treated/sprayed with the treatment aerosol immediately after exiting a melt blowing die apparatus. The treatment aerosol may be supplied by the respective two-fluid nozzle to the outlet opening of a melt blowing die apparatus for spraying/treatment of the fibres. This ensures a particularly reliable process mode for electrostatic charging of the respective fibres.

In yet a further preferred embodiment after spraying with the treatment aerosol the fibres may be consolidated to afford a fibre nonwoven and/or laid down on a collecting apparatus, in particular a laydown belt. Treating/spraying the fibres with the treatment aerosol may thus be carried out between discharge of the fibres from the respective die apparatus and laydown on a collecting apparatus or capture by a vacuum apparatus. The consolidated fibres may thus already be sufficiently electrostatically charged at the time of laydown or capture.

The fibres consolidated to afford a fibre construct and/or fibre nonwoven and/or laid down on a collecting apparatus, in particular a laydown belt, can further preferably have a residual moisture content of less than 6%, in particular of less than 5%, without active drying. The use of a specific apparatus for active drying of the fibres or the consolidated fibre construct and/or fibre nonwoven may accordingly be avoided, thus making it possible to keep down the apparatus costs for performing the process.

Such a process preferably makes it possible to produce electrostatically charged fibres laid down on the collecting apparatus which have a very low residual moisture content. An additional active drying using additional drying apparatuses may therefore be avoided. A pure vacuum extraction means (or device) at a collecting apparatus/at a laydown belt can likewise sufficiently dry the laid down fibre construct/fibre nonwoven without any need for a separate drying apparatus.

A collecting apparatus may be in the form of a laydown belt, in particular in the form of a vacuum conveyor belt, a vacuum laydown screen and/or laydown grid and/or an electrically conductive laydown grid. A vacuum means (or device) can ensure separation of the previously introduced media, such as air and/or water, from the laid down fibre construct, in particular fibre nonwoven. In so-called electrospinning the laydown grid may also be electrically conductive.

Production of the fibres can yet further preferably employ at least one additive or a combination of additives for charge stabilization. These include for example fatty acids, in particular distearylethylenediamide, and/or salts thereof, preferably magnesium stearate, sterically hindered amides, preferably Chimmasorb 944, fluorine compounds and/or polymers and/or combinations thereof. This makes it possible to very reliably retain an electrostatic charge of the fibres so that the properties of a respectively produced product, in particular electret product, can be very reliably retained over a relatively long period.

The polar liquid may yet further preferably include at least one additive for improving charging, durability and/or filtration efficiency of the electrostatic charge and/or for semipermanent charging. A fibre treated with such a liquid/pretreatment aerosol produced therefrom can ensure particularly advantageous properties, in particular in respect of the degree of charging and the durability of the charge. Fibre constructs or fibre nonwovens produced from thus-treated fibres exhibit a particularly advantageous filtration performance which is also retained over a long period.

Yet a further aspect of the present invention relates to an apparatus for producing electrostatically charged fibres, in particular for producing an electret fibre construct and/or for producing electret fibres and/or an electret fibre nonwoven. Such an apparatus may in particular be suitable for performing an above-described process.

An apparatus according to the invention is provided with a spinning apparatus for producing fibres from a plastics and/or natural-origin material and with a nozzle apparatus for producing a treatment aerosol by atomizing a polar liquid using a gaseous pressure medium and for electrostatic charging of the fibres by spraying the fibres with the treatment aerosol. According to the invention it is now provided that the nozzle apparatus is configured for undertaking the atomizing with a quotient of the volume flow of the polar liquid in litres per hour and the positive pressure of the gaseous pressure medium in hectopascals of 0.004 to 0.008 and/or with a quotient of the mass flow of the polar liquid and the mass flow of the gaseous pressure medium of 1.4 to 3 and/or with a quotient of the volume flow of the polar liquid and the volume flow of the gaseous pressure medium of 0.001 to 0.004.

Using such an apparatus allows a relatively large amount of charges to be produced and applied to the respectively produced fibres. Simultaneously, such quotients/ratios allow the amount of the produced treatment aerosol to be sufficiently limited or minimized. This makes it possible to ensure that an only relatively slight moistening of the fibres or of the fibre construct is effected. An active drying of the electrostatically charged fibres can accordingly be avoided, thus appreciably reducing the apparatus costs and the energy costs required for production. The sufficient electrostatic charge simultaneously ensures a high filtration efficiency of the fibres/fibre constructs produced with such an apparatus.

During operation of such an apparatus the spinning apparatus can preferably discharge a melt which is withdrawn with process air. This can produce a so-called free jet. A free jet refers to a fibre-bearing flow of air and polymer filaments for example. It is preferable when a fibre construct/a fibre nonwoven is producible from the free jet only on a collecting apparatus, wherein the proportion of air and treatment aerosol may be removed by vacuum extraction.

It is further preferable when only a certain portion of fibres in the free jet are electrostatically charged while some of the fibres or portions of the fibres do not experience electrostatic charging. Electrostatic charging of the respective fibres may be undertaken until the point of saturation charging.

In a preferred embodiment of the apparatus the nozzle apparatus may include a two-fluid nozzle or a plurality of two-fluid nozzles, wherein a plurality of two-fluid nozzles is preferably arranged at a distance of 4 cm to 10 cm, in particular a distance of 5 cm to 8 cm or a distance of 7 cm or about 7 cm to one another. This allows fibres from a multiplicity of capillary tubes of a melt spinning apparatus/melt blowing die apparatus to be suitably/uniformly treated.

The openings of the two-fluid nozzles may further preferably be arranged at an angle relative to the horizontal, in particular at an angle of 1° to 30°, preferably of 5° to 20°. Such an arrangement makes it possible to produce a relatively well distributed aerosol mist and thus a particularly uniform treatment of fibres.

In a further preferred embodiment the spinning apparatus may be in the form of a melt blowing apparatus, in the form of a melt spinning apparatus, in particular with an Exxon die or single- or multi-row coaxial dies or spunbond dies, or in the form of a solvent spinning apparatus. A nozzle apparatus according to the invention may consequently be employed in different types of spinning apparatuses/in different processes, such as for example in melt spinning processes, in melt blowing processes, also known as “meltblown processes” and/or in solvent spinning processes.

When performing a melt blowing/meltblown process the free jet/thread velocity may be a so-called “whip velocity”. This may be reported for example via the throughput per capillary opening (holes per inch) in the respective spinning apparatus.

The material throughput of a spinning apparatus in the melt blowing process/meltblown process may preferably be in a range of 0.5 to 100 kg/h/m, wherein the length in metres is presently to be understood as referring to the apparatus width or apparatus length. A multiplicity of capillary openings may be provided along the apparatus width or apparatus length. The example range of 0.5 to 100 kg/h/m may thus be from the number of capillaries of the respective spinning apparatus (Exxon die and/or coaxial die).

The meltblown process may employ for example a spinning apparatus having altogether 1968 capillary openings per metre. This can be used to calculate a melt throughput per capillary opening from the throughput of the respective melt conveying pump of 30 kg/h/m as follows:

30 kg/h/m/1968 capillary openings/m=0.015 kg/h/capillary opening

A throughput of a melt conveying pump in the range of 10-50 kg/h/m and a spinning apparatus including a melt blowing die apparatus having about 1500-2500 capillary openings/m can be used to produce a throughput per capillary opening of 0.0066 to 0.2 kg/h.

In a preferred embodiment of the present process and/or the present apparatus a material throughput of 0.0066 to 0.2 kg/h can be produced per capillary opening of the respective spinning apparatus.

The material throughput of a spinning apparatus in the spunbond process may further preferably be in the range from 1 to 400 kg/h/m.

The material throughput of a spinning apparatus in solvent spinning may yet further preferably be in the range from 0.001 to 20 kg/h/m.

A process according to the invention/an apparatus according to the invention makes it possible to electrostatically charge any suitable fibre/filter material, thus improving its filtration efficiency.

Finally, yet a further aspect of the present invention relates to an electret product, in particular an electret fibre and/or an electret fibre nonwoven, produced by an above-described process and/or with an above-described apparatus. An electret product may in particular be a semi-permanently or permanently electrostatically charged product.

Such an electret product, in particular such an electret fibre nonwoven or electret fibre construct, can have a high quality factor (Q factor), for example a Q factor of 10-20, especially preferably of 14-17. The Q factor describes the filtration efficiency/filtration performance of the respective product. The Q factor is an important indicator of quality for use in respirator masks for example.

The Q factor is also used for comparing the filtration performance of different nonwovens. The Q factor is calculated from the quotient of penetration by pressure drop according to equation [I].

$$Q = \frac{ln ( \frac{1}{\frac{penetration}{100}} )}{pressure drop} \times 100$$

Penetration is calculated according to ln(1/penetration/100) and pressure drop is preferably reported in hectopascal.

The Q factor is also dependent on the measurement apparatus used. The Q factor is preferably determined using a TSI 8130 instrument from TSI with a 2% NaCl solution and a volume flow of 48 l/min.

The above-described preferred embodiments and advantages in respect of the process for producing electrostatically charged fibres apply correspondingly to the above-described apparatus for producing electrostatically charged fibres and also to the described electret product.

The invention will now be described by way of example with reference to the accompanying figures. In the figures:

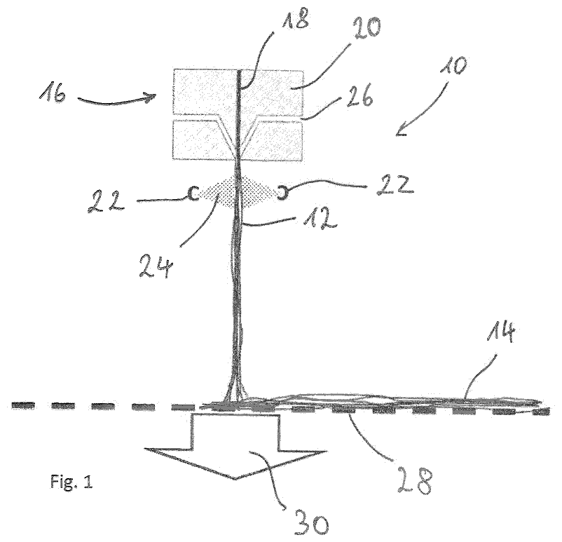

FIG. 1 shows a section of an inventive apparatus according to an example embodiment of the present invention,

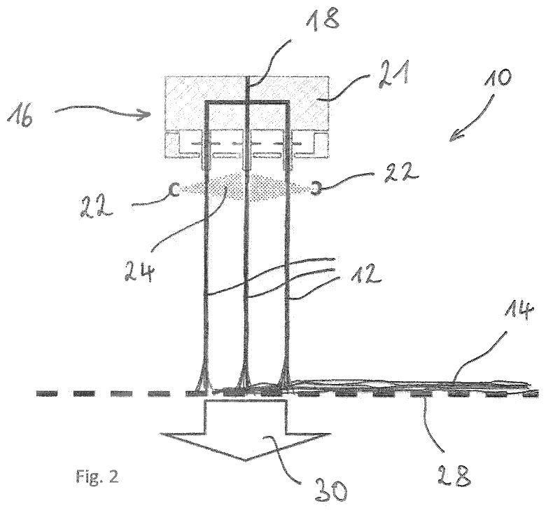

FIG. 2 shows a section of an inventive apparatus according to a further example embodiment of the present invention,

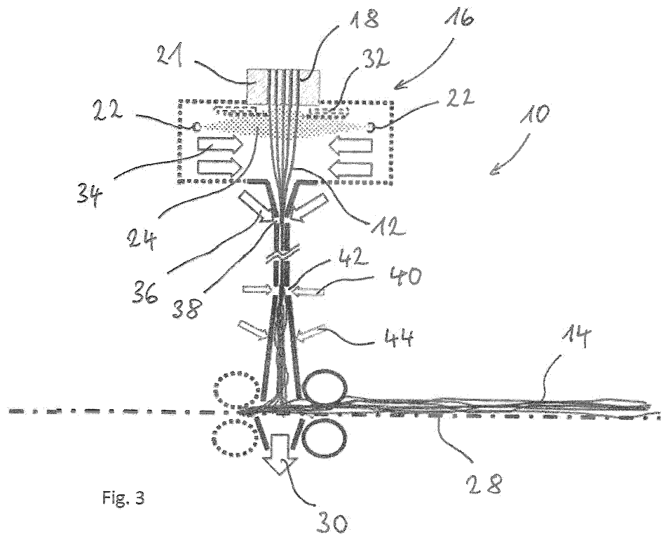

FIG. 3 shows a section of an inventive apparatus according to yet a further example embodiment of the present invention,

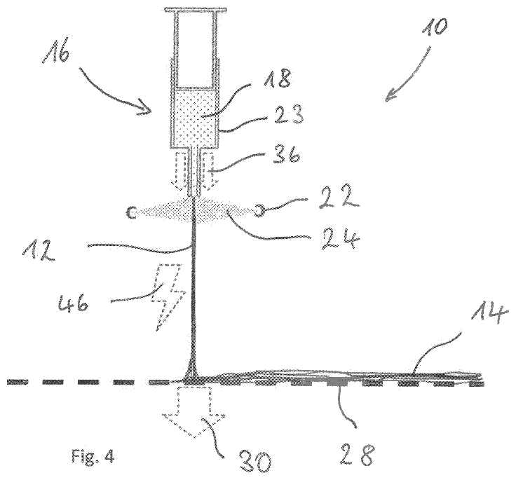

FIG. 4 shows a section of an inventive apparatus according to yet a further example embodiment of the present invention,

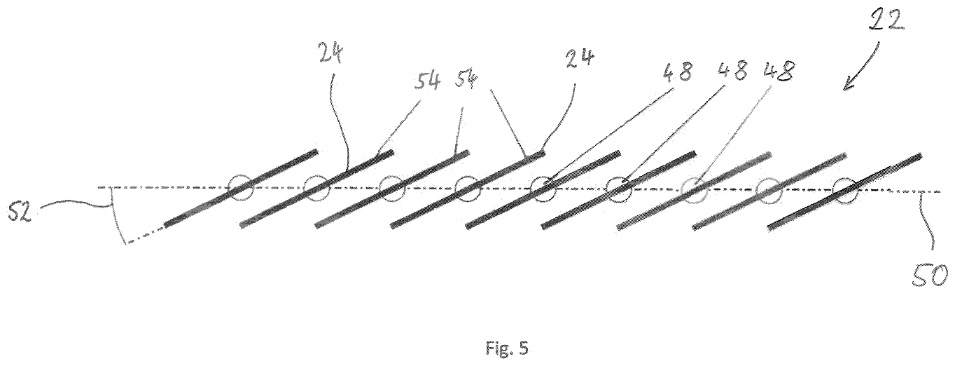

FIG. 5 shows a side view of a nozzle apparatus of an inventive apparatus for producing electrostatically charged fibres.

FIG. 1 shows a section of an inventive apparatus 10 according to one example embodiment of the present invention. The apparatus 10 is configured for producing electrostatically charged fibres 12, in particular for producing an electret fibre construct 14.

The apparatus 10 according to the example embodiment in FIG. 1 includes a spinning apparatus 16 for producing fibres 12 from a polymer material 18. The spinning apparatus 16 may be in the form of a melt blowing apparatus/meltblown apparatus according to FIG. 1 and to this end include a melt blowing die apparatus 20. The melt blowing die apparatus 20 may in particular be a so-called Exxon die.

The apparatus 10 may thus be a melt blowing plant/a meltblown plant.

Inside the melt blowing die apparatus 20 the polymer material 18 may be in the form of polymer melt/introduced into the melt blowing die apparatus 20 in the form of polymer melt.

The apparatus 10 according to FIG. 1 further includes a nozzle apparatus 22 for producing a treatment aerosol 24 for atomizing a polar liquid using a gaseous pressure medium. The nozzle apparatus 22 is configured for electrostatically charging the fibres 12 by spraying the fibres 12 with the treatment aerosol 24.

The nozzle apparatus 22 is configured for undertaking the atomizing with a quotient of the volume flow of the polar liquid of 3.2 to 5.2 litres per hour and the positive pressure of the gaseous pressure medium in hectopascals of 0.004 to 0.008. Alternatively or in addition the nozzle apparatus 22 may be configured for undertaking the atomizing with a quotient of the mass flow of the polar liquid and the mass flow of the gases pressure medium of 1.4 to 3. The nozzle apparatus 22 may be likewise be configured for undertaking the atomizing with a quotient of the volume flow of the polar liquid and the volume flow of the gases pressure medium of 0.001 to 0.004.

Using such a quotient/such a ratio allows a relatively large amount of charges to be produced and applied to the fibres 12. Such a quotient/such a ratio likewise allows the amount of the produced treatment aerosol 24 to be sufficiently limited or minimized. This ensures that an only relatively slight moistening of the fibres 12 or of the fibre construct 14 is effected. An active drying of the electrostatically charged fibres 12/of the fibre construct 14 can accordingly be avoided, thus reducing the production costs and the energy costs required for production. The sufficient electrostatic charge simultaneously ensures a high filtration efficiency of the fibre construct 14 produced from fibres 12 produced in such a way.

The melt blowing die apparatus 20 according to FIG. 1 includes at least one air channel 26 through which an air stream is directed onto the produced fibres 12, in particular acts tangentially on the fibres 12, in order to stretch the fibres.

After treatment of the fibres 12 with the treatment aerosol 24 the fibres are laid down on a collecting apparatus 28. The collecting apparatus 28 may be a laydown belt for example. An air stream 30 for vacuum aspiration/vacuum extraction may be used for the laydown or consolidation of the fibres 12 on the collecting apparatus 28. The air stream 30 may be provided by a vacuum aspiration and/or vacuum extraction apparatus (not shown here). The vacuum aspiration/vacuum extraction and laydown of the fibres 12 makes it possible to achieve sufficient drying of the fibres 12 treated with the treatment aerosol 24 since the nozzle apparatus 22 effects only limited moistening. The laydown or consolidation of the fibres 12 on the collecting apparatus 28 makes it possible to produce a fibre construct 14, for example a fibre nonwoven.

FIG. 2 shows a section of an inventive apparatus 10 according to a further example embodiment of the present invention. The apparatus 10 according to FIG. 2 is also configured for producing electrostatically charged fibres 12, in particular for producing an electret fibre construct 14.

The apparatus 10 according to FIG. 2 includes a spinning apparatus 16 for producing fibres 12 from a polymer material 18. The apparatus 10 according to FIG. 2 differs from the apparatus according to FIG. 1 in the configuration of the spinning apparatus 16. The spinning apparatus 16 according to FIG. 2 may be in the form of a melt spinning apparatus and to this end include a melt spinning die apparatus 21. The melt spinning die apparatus 21 may include for example single- or multi-row coaxial dies.

The apparatus 10 according to FIG. 2 may thus be a melt spinning plant.

According to FIG. 2 the spinning apparatus 16 produces a plurality of rows of strands of fibres 12/rows of fibre jets. The nozzle apparatus 22 may be adapted or arranged for treating all fibres 12 or all rows of fibres 12 with the treatment aerosol 24.

FIG. 3 shows a section of an inventive apparatus 10 according to yet a further example embodiment of the present invention. The apparatus 10 according to FIG. 3 is also configured for producing electrostatically charged fibres 12, in particular for producing an electret fibre construct 14.

Different embodiments of the apparatus 10 are shown in FIG. 3. Either compacting rollers 56, represented by a solid line, may be arranged in the conveying direction of the collecting apparatus 28 or sealing rollers 56, represented by a dotted line, may be arranged counter to the conveying direction of the collecting apparatus 28. In one embodiment both compacting rollers 56 and sealing rollers 56 may be provided. The compacting rollers 56 compact the fibre construct and to the sealing rollers have a sealing function.

The apparatus 10 according to FIG. 3 likewise includes a spinning apparatus 16 for producing fibres 12 from a polymer material 18. The apparatus 10 according to FIG. 3 in turn differs from the apparatus according to FIG. 1 or FIG. 2 in the configuration of the spinning apparatus 16. The spinning apparatus 16 according to FIG. 3 may be in the form of a melt spinning apparatus and to this end include a melt spinning die apparatus 21. The melt spinning die apparatus 21 may in particular include single- or multi-row spunbond dies.

The apparatus 10 according to FIG. 3 may thus be a melt spinning plant in which a stretching is carried out after employing a fibre/filament cooling as described below.

According to FIG. 3 the spinning apparatus 16 produces a plurality of rows of strands of fibres 12/rows of fibre jets. The nozzle apparatus 22 may be adapted or arranged for treating all fibres 12 or all rows of fibres 12 with the treatment aerosol 24.

Before the fibres 12 are subjected to a treatment with the treatment aerosol 24 an oligomer and/or spinning fume vacuum extraction 32 may optionally be undertaken using a vacuum extraction apparatus (not shown here).

Following the treatment with the treatment aerosol 24 via the nozzle apparatus 22 the fibres 12 are subjected to a cooling 34, in particular an air cooling/a so-called air quenching. A cooling apparatus (not shown here) may be employed to this end.

Following the cooling 34 the fibres 12 are stretched by a primary air 36/stretching air. The primary air 36/stretching air may be supplied via an air supply 38. In the further course of the fibres 12 these may optionally be supplied with a secondary air 40 via the air supply 42 and a tertiary air 44 via an air supply not shown here.

The primary air is conducted in a spinning shaft 58 together with the fibres 12. The spinning shaft 58 may be circular and/or rectangular and be formed from a continuous spinning/58 or from spinning shaft portions spaced apart from one another.

After the treatment of the fibres 12 with the treatment aerosol 24 and also the cooling 34, the stretching by means of the primary air 36 and optionally the supplying of a secondary air 40 and tertiary air 44 the fibres 12 may be laid down/consolidated on a collecting apparatus 28 as described hereinabove in respect of the example embodiment in FIG. 1.

FIG. 4 shows a section of an inventive apparatus 10 according to yet a further example embodiment of the present invention. The apparatus 10 according to FIG. 4 is also configured for producing electrostatically charged fibres 12, in particular for producing an electret fibre construct 14.

The apparatus 10 according to FIG. 4 likewise includes a spinning apparatus 16 for producing fibres 12 from a polymer material 18. The apparatus 10 according to FIG. 4 in turn differs from the apparatus according to FIG. 1, FIG. 2 or FIG. 3 in terms of the configuration of the spinning apparatus 16. The spinning apparatus 16 according to FIG. 4 is thus configured as a solvent spinning apparatus and to this end may include a solvent die apparatus 23. Inside the solvent die apparatus 23 the polymer material 18 may be in the form of a polymer solution.

The apparatus 10 according to FIG. 4 may thus be a solvent spinning plant.

Before the fibres 12 are subjected to a treatment with the treatment aerosol 24 a stretching of the fibres 12 by a primary air 36/stretching air may optionally be carried according to the embodiment in FIG. 4. The primary air 36/stretching air may be supplied via an air supply not shown here. After the optional stretching by the primary air 36/stretching air the fibres 12 the fibres are treated with the treatment aerosol 24 for electrostatic charging via the nozzle apparatus 22.

In the further course of the fibres 12 these may optionally be passed through an electric field 46. The electric field 46 may in particular be a high-voltage field. The passage through the electric field 46 may likewise or additionally effective a stretching of the fibres 12. In the example embodiment according to FIG. 4 a stretching of the fibres 12 may alternatively or in addition be brought about by a centrifugal force.

In the example embodiment in FIG. 4 too, the fibres 12 may be laid down/consolidated on a collecting apparatus 28 as described hereinabove in respect of the example embodiment in FIG. 1.

FIG. 5 shows a side view of a nozzle apparatus 22 of an inventive apparatus 10 for producing electrostatically charged fibres 12. The nozzle apparatus 22 may include a plurality of two-fluid nozzles 48. The two-fluid nozzles 48 may in particular be arranged along a horizontal 50 shown in schematic form. The two-fluid nozzles 48 may in particular be in the form of flat jet nozzles.

The openings of the two-fluid nozzles 48 may be arranged at an angle 52 relative to the horizontal 50, in particular at an angle 52 of 1° to 30°, preferably of 5° to 20°. As a result, the treatment aerosol 24 can exit the opening of the respective two-fluid nozzle 48 in a flat jet 54 which is likewise at an angle 52 to the horizontal 50. A plurality of such flat jets 54 allow the treatment aerosol 24 to be relatively well distributed in the space.

### LIST OF REFERENCE DESIGNATIONS

10 Apparatus
12 Fibres
14 Fibre constructs
16 Spinning apparatus
18 Polymer material
20 Melt blowing die apparatus
21 Melt spinning die apparatus
22 Nozzle apparatus
23 Solvent die apparatus
24 Treatment aerosol
26 Air channel
28 Collecting apparatus
30 Air stream
32 Oligomer and/or spinning fume vacuum extraction
34 Cooling
36 Primary air
38 Air supply
40 Secondary air
42 Air supply
44 Tertiary air
46 Electric field
48 Two-fluid nozzles
50 Horizontal
52 Angle
54 Flat jet
56 Sealing roller/compacting roller
58 Spinning shaft

1. Process for producing electrostatically charged fibres, in particular for producing an electret fibre construct,
where fibres are produced from a plastics and/or natural-origin material,
where a polar liquid is atomized using a gaseous pressure medium to produce a treatment aerosol and
where the fibres are treated with the treatment aerosol for electrostatic charging,
wherein the atomizing is undertaken with a quotient of the volume flow of the polar liquid in litres per hour and the positive pressure of the gaseous pressure medium in hectopascals of 0.004 to 0.008 and/or with a quotient of the mass flow of the polar liquid and the mass flow of the gaseous pressure medium of 1.4 to 3 and/or with a quotient of the volume flow of the polar liquid and the volume flow of the gaseous pressure medium of 0.001 to 0.004.

2. (canceled)

3. (canceled)

4. Process according to claim 1, wherein the atomizing of the polar liquid is undertaken via at least one two-fluid nozzle, in particular with a plurality of two-fluid nozzles.

5. Process according to claim 4, wherein the atomizing may be undertaken in a two-fluid nozzle or per two-fluid nozzle at a volume flow of the polar liquid of 3.2 litres per hour to 5.2 litres per hour, in particular at a volume flow of the polar liquid of 4.2 litres per hour or about 4.2 litres per hour.

6. Process according to claim 1, wherein the atomizing of the polar liquid is undertaken at a positive pressure of the gaseous pressure medium of 500 to 900 hectopascals, in particular at a positive pressure of the gaseous pressure medium of 700 hectopascals or about 700 hectopascals.

7. Process according to claim 4, wherein the atomizing is undertaken in a two-fluid nozzle or per two-fluid nozzle at a mass flow of the gaseous pressure medium of 2.1 to 2.7 kilograms per hour, in particular at a mass flow of the polar liquid of 2.1 to 2.5 kilograms per hour or 2.3 to 2.7 kilograms per hour.

8. Process according to claim 4, wherein the atomizing may be undertaken in a two-fluid nozzle or per two-fluid nozzle at a volume flow of the gaseous pressure medium of 1.5 to 2.5 cubic metres per hour, in particular at a volume flow of the polar liquid of 0.002-0.008 cubic metres per hour.

9. Process according to claim 1, wherein the fibres are sprayed with the treatment aerosol before consolidation to afford a fibre construct and/or fibre nonwoven and/or before laydown on a collecting apparatus and/or before capture by a vacuum source.

10. Process according to claim 1, wherein the fibres are produced by melt blowing and/or in that the fibres are sprayed with the treatment aerosol immediately after exiting a melt blowing die apparatus and/or in that the treatment aerosol is supplied to the outlet opening of a melt blowing die apparatus for spraying of the fibres.

11. Process according to claim 1, wherein after spraying with the treatment aerosol the fibres are consolidated to afford a fibre construct and/or a fibre nonwoven and/or laid down on a collecting apparatus and/or in that the fibres consolidated to afford a fibre construct and/or fibre nonwoven and/or laid down on a collecting apparatus have a residual moisture content of less than 6%, in particular of less than 5%, without active drying.

12. Apparatus for producing electrostatically charged fibres, in particular for performing a process,
with a spinning apparatus for producing fibres from a plastics and/or natural-origin material and
with a nozzle apparatus for producing a treatment aerosol by atomizing a polar liquid using a gaseous pressure medium and for electrostatic charging of the fibres by spraying the fibres with the treatment aerosol,
wherein the nozzle apparatus is configured for undertaking the atomizing with a quotient of the volume flow of the polar liquid in litres per hour and the positive pressure of the gaseous pressure medium in hectopascals of 0.004 to 0.008 and/or with a quotient of the mass flow of the polar liquid and the mass flow of the gaseous pressure medium of 1.4 to 3 and/or with a quotient of the volume flow of the polar liquid and the volume flow of the gaseous pressure medium of 0.001 to 0.004.

13. Apparatus according to claim 12, wherein the nozzle apparatus comprises a two-fluid nozzle or a plurality of two-fluid nozzles, wherein a plurality of two-fluid nozzles is preferably arranged at a distance of 4 cm to 10 cm, in particular a distance of 5 cm to 8 cm or a distance of 7 cm or about 7 cm to one another and/or in that the openings of the two-fluid nozzles are arranged at an angle relative to the horizontal , in particular at an angle of 1° to 30°, preferably of 5° to 20°.

14. Apparatus according to claim 12, wherein spinning apparatus is in the form of a melt blowing apparatus, in the form of a melt spinning apparatus, in particular with an Exxon die or single- or multi-row coaxial dies or spunbond dies, or in the form of a solvent spinning apparatus.

15. Electret article, in particular electret fibre and/or an electret fibre nonwoven, produced by a process
where fibres are produced from a plastics and/or natural-origin material,
where a polar liquid is atomized using a gaseous pressure medium to produce a treatment aerosol and
where the fibres are treated with the treatment aerosol for electrostatic charging,
wherein the atomizing is undertaken with a quotient of the volume flow of the polar liquid in litres per hour and the positive pressure of the gaseous pressure medium in hectopascals of 0.004 to 0.008.
